(19) United States
(12) Patent Application Publication
(10) Pub. No.: US 2011/0296103 A1
(43) Pub. Date: Dec. 1, 2011

(54) STORAGE APPARATUS, APPARATUS CONTROL METHOD, AND RECORDING MEDIUM FOR STORAGE APPARATUS CONTROL PROGRAM

(75) Inventors: Atsushi IGASHIRA, Kawasaki (JP); Hideo Takahashi, Kawasaki (JP); Norihide Kubota, Kawasaki (JP); Kenji Kobayashi, Kawasaki (JP); Hidejirou Daikokuya, Kawasaki (JP); Kazuhiko Ikeuchi, Kawasaki (JP); Chikashi Maeda, Kawasaki (JP)

(73) Assignee: FUJITSU LIMITED, Kawasaki-shi (JP)

(21) Appl. No.: 13/116,298

(22) Filed: May 26, 2011

(30) Foreign Application Priority Data
May 31, 2010 (JP) 2010-124578

(51) Int. Cl. G06F 12/00

(52) U.S. Cl. 711/114; 711/E12.001

(57) ABSTRACT

According to an embodiment, a storage apparatus including: a plurality of storage media of which a first RAID is composed, a logical storage area of the first RAID for storing data being set over; a plurality of expansion storage media of which a second RAID is composed; a spare storage medium that is different from in any of the storage media or the expansion storage media; and a configuration control unit that when the spare storage medium is set in the first RAID, sets the logical storage area in the storage media, and when the expansion storage media are set in the storage apparatus, sets the expansion storage media in the second RAID, excludes the spare storage medium that is set in the first RAID, and moves the logical storage area that is set in the first RAID to the second RAID.

### CROSS-REFERENCE TO RELATED APPLICATION

This application is based upon and claims the benefit of priority of the prior Japanese Patent Application No. 2010-124578, filed on May 31, 2010, the entire contents of which are incorporated herein by reference.

### FIELD

The present invention relates to a storage apparatus, a storage apparatus control method, and a recording medium for a storage apparatus control program.

### BACKGROUND

Storage capacity of storage apparatuses using storage media such as magnetic disks, magneto-optical disks, or optical disks has been increased. In association with the increase in the storage capacity of such storage apparatuses, RAID (Redundant Arrays of Inexpensive Disks) that is a technology of duplexing storage media to configure a storage apparatus is widely used. Japanese Laid-open Patent Publication No. 2009-37304 and Japanese Laid-open Patent Publication No. 2004-213064 disclose techniques relating to management and change of the configuration of the storage apparatus using RAID.

The storage capacity necessary for a storage apparatus may gradually increase as data used for the operation of the storage apparatus is accumulated. In such a case, in general, storage media are added to the storage apparatus, or a storage medium in the storage apparatus is replaced with another storage medium having a larger capacity in order to increase the storage capacity used for operation of the storage apparatus. However, if storage media are repeatedly increased or replaced in a storage apparatus, labor and cost involved in the work may increase.

In addition, if a storage apparatus is continuously operated in a state in which the amount of data stored in the storage apparatus almost reaches an upper limit of the storage capacity, it becomes difficult for the storage apparatus to sufficiently exhibit its performance, and the throughput may be reduced.

The storage capacity of a storage apparatus may be logically increased and physical storage media may be efficiently used when using Thin Provisioning technique. However, Thin Provisioning does not increase the physical storage capacity of the storage apparatus. Therefore, when a remaining physical storage capacity is reduced, a storage medium may be replaced with another storage medium or another storage medium is added. As a result, labor and cost involved in the work may increase.

### SUMMARY

According to an embodiment, a storage apparatus including: a plurality of storage media of which a first RAID is composed, a logical storage area of the first RAID for storing data being set over; a plurality of expansion storage media of which a second RAID is composed; a spare storage medium that is different from in any of the storage media or the expansion storage media; and a configuration control unit that when the spare storage medium is set in the first RAID, sets the logical storage area in the storage media, and when the expansion storage media are added to the storage apparatus, sets the expansion storage media in the second RAID, excludes the spare storage medium that is set in the first RAID, and moves the logical storage area that is set in the first RAID to the second RAID.

The object and advantages of the embodiment will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a storage apparatus according to a first embodiment;

FIG. 2 is a diagram illustrating a hardware configuration of a storage apparatus according to a second embodiment;

FIG. 3 is a block diagram illustrating functions of the storage apparatus according to the second embodiment;

FIG. 4 is a diagram illustrating a configuration management table in the second embodiment;

FIG. 5 is a diagram illustrating configurations of RAID groups in a normal state in the second embodiment;

FIG. 6 is a diagram illustrating an operation of adding a spare storage device in the second embodiment;

FIG. 7 is a diagram illustrating an operation of adding a RAID group in the second embodiment;

FIG. 8 is a diagram illustrating a configuration management table indicating a state in which a spare storage device is added and a RAID group is added in the second embodiment;

FIG. 9 is a flowchart illustrating a process of temporarily increasing the storage capacity in the second embodiment;

FIG. 10 is a diagram illustrating an operation of moving an added RAID group to storage devices increased in the second embodiment;

FIG. 11 is a diagram illustrating an operation of rewriting data into storage devices in a RAID group in which the storage capacity is reduced in the second embodiment;

FIG. 12 is a diagram illustrating a configuration of RAID after the increase of storage devices in the second embodiment;

FIG. 13 is a diagram illustrating a configuration management table indicating a state in which storage devices are increased in the second embodiment;

FIG. 14 is a flowchart illustrating a process of increasing storage devices in the second embodiment;

FIG. 15 is a flowchart illustrating a process of increasing storage devices in the second embodiment;

FIG. 16 is a flowchart illustrating a process of increasing storage devices in the second embodiment; and

FIG. 17 is a flowchart illustrating a process of increasing storage devices in the second embodiment.

### DESCRIPTION OF EMBODIMENTS

Next, embodiments will be described with reference to the accompanying drawings.

### First Embodiment

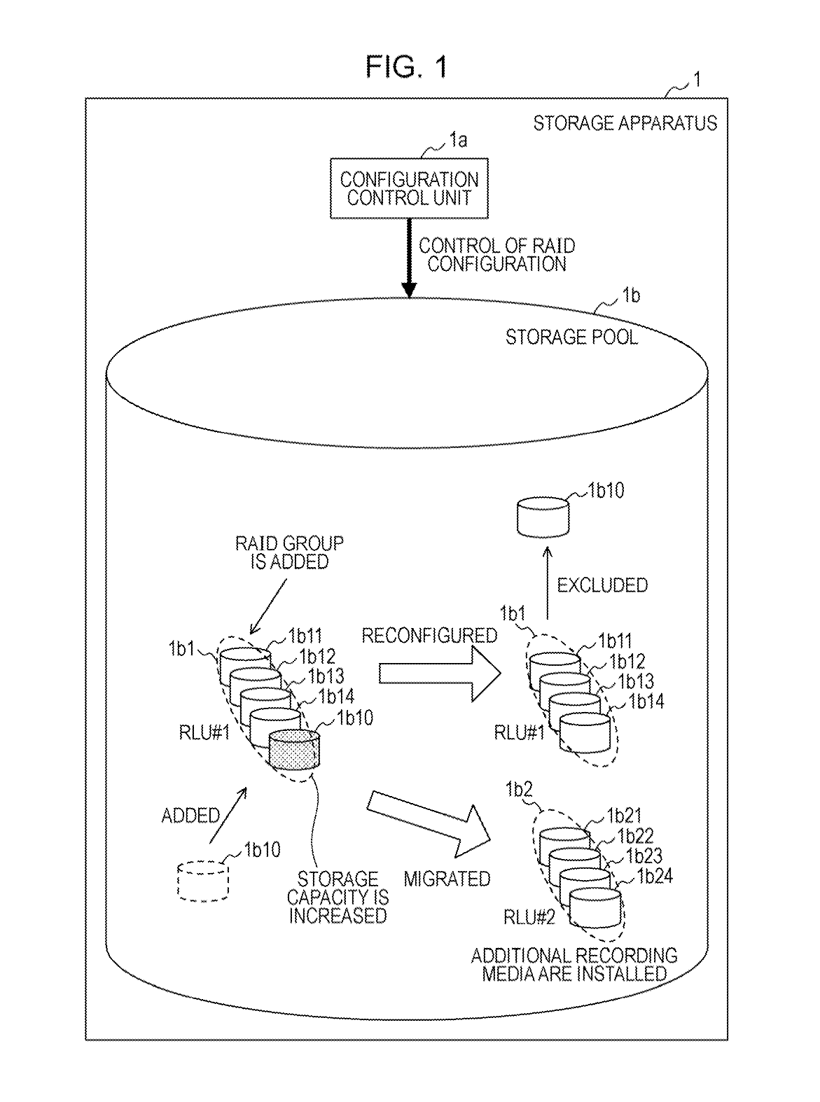

FIG. 1 is a diagram illustrating a storage apparatus according to a first embodiment. A storage apparatus 1 according to the first embodiment includes a configuration control unit 1a and a storage pool 1b. The storage pool 1b includes RAID 1b1 and a spare storage medium 1b10. A RAID group which is a logical storage area such as, for example, an RLU (RAID Logical Unit) #1 or the like is set in the RAID 1b1 and data is stored in the set RAID group. In addition, storage media 1b21, 1b22, 1b23 and 1b24 may be increased in the storage pool 1b and RAID 1b2 may be set in the increased storage media 1b21 to 1b24.

When the storage capacity of the storage pool 1b is reduced, for example, the storage capacity of the storage pool 1b is reduced to 10% or less of its maximum storage capacity, the configuration control unit 1a adds the spare storage medium 1b10 and an RLU#2 (a logical storage area) which is a new RAID group to the RAID 1b1 including storage media 1b11, 1b12, 1b13 and 1b14.

When the storage media 1b21 to 1b24 are increased in the storage pool 1b, the configuration control unit 1a excludes the spare storage medium 1b10 which has been added to the RAID 1b1, sets the RAID 1b2 including the increased storage media 1b21 to 1b24 and moves data of the RLU#2, which has been added when the spare storage medium 1b10 has been added, into the RAID 1b2 which is set in the increased storage media 1b21 to 1b24. As a result, only the RLU#1 is again set in the RAID 1b1.

The RAID 1b1 is configured using the storage media 1b11 to 1b14 (or the storage media 1b11 to 1b14 and the spare storage medium 1b10). The storage media 1b11 to 1b14 have storage areas into which data may be stored. The storage apparatus 1 stores data sent from another computer or the like (not illustrated) in each RAID group which is set in the RAID 1b1 or the like. Likewise, the RAID 1b2 is configured using a plurality of storage media (for example, the storage media 1b11 to 1b14 and the spare storage medium 1b10, or the increased storage media 1b21 to 1b24). The RAID 1b1 and RAID 1b2 may be set using an optional number of storage media.

The spare storage medium 1b10 is a storage medium which is used as a spare, includes a storage area in which data may be stored and is normally on standby in a power-on state without belonging to any RAID configuration. When a fault has occurred in a storage medium in the RAID 1b1 or in another RAID, the spare storage medium 1b10 is incorporated in place of the fault-occurred storage medium into the RAID to which the fault-occurred storage medium has belonged. The spare storage medium 1b10 may be on standby in a power-off state and the power source may be turned on when the spare storage medium 1b10 is used.

As described above, according to the first embodiment, the spare storage medium 1b10 is used to temporarily increase the storage capacity for a time period until the storage media 1b21 to 1b24 are increased in the storage apparatus 1. When the storage media 1b21 to 1b24 have been increased in the storage apparatus 1, the spare storage medium 1b10 is excluded from the RAID configuration and returned to the standby to be used as a spare. RAID is configured using the increased storage media 1b21 to 1b24 and data which has been stored in a storage area prepared using the spare storage medium 1b10 is moved to the RAID which is configured using the increased storage media 1b21 to 1b24. As a result, the number of increasing storage media in the storage apparatus 1 and replacing a storage medium with another storage medium may be reduced.

### Second Embodiment

Next, an embodiment in which a function of the storage apparatus 1 illustrated in FIG. 1 that the storage capacity is temporarily increased using the spare storage medium is applied to a storage apparatus 100 that includes storage groups that configure RAID will be described as a second embodiment.

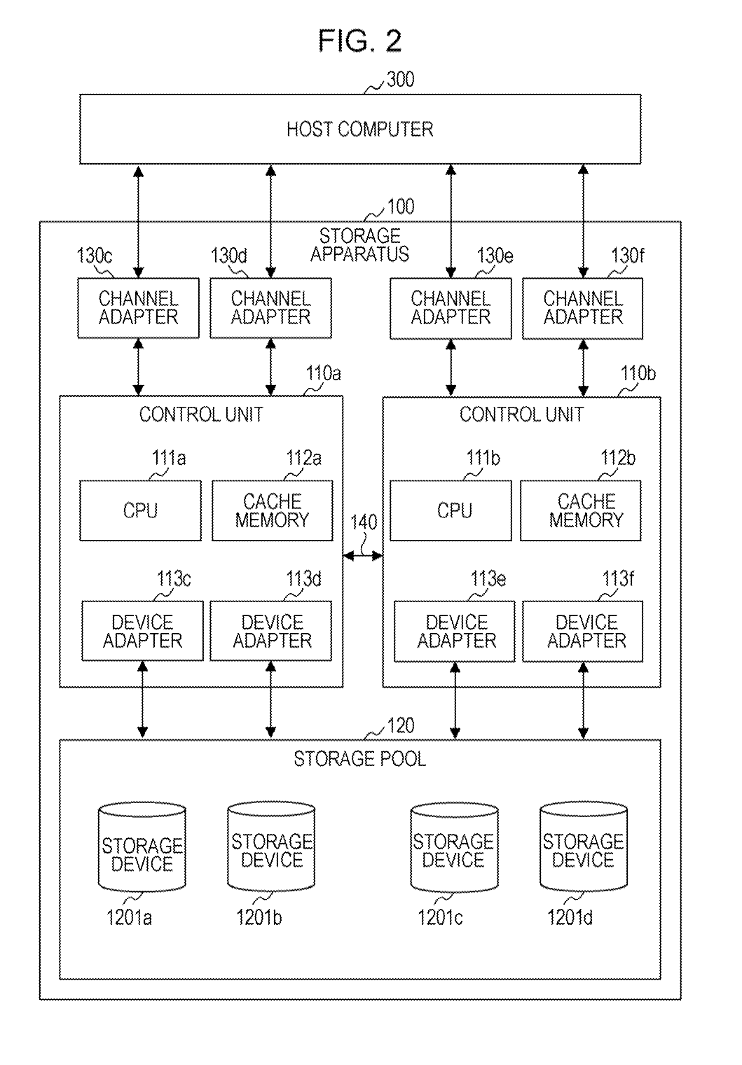

FIG. 2 is a diagram illustrating a hardware configuration of the storage apparatus 100 according to the second embodiment. The storage apparatus 100 includes control units 110a and 110b that control the entire operation of the apparatus, channel adapters 130c to 130f that control connection between the control units 110a and 110b and a host computer 300, and a storage pool 120 including storage devices 1201a, 1201b, 1201c and 1201d and a plurality of other storage devices (not illustrated).

The storage apparatus 100 operates to input data into and output data from a plurality of storage devices such as, for example, hard disk drives (HDDs) which will be described later. The storage apparatus 100 has RAID functions such as, for example, RAID 0 to RAID 6 and, uses a plurality of storage devices to configure RAID and manages RAID as one storage device.

The host computer 300 executes task processing and is connected to the storage apparatus 100 via a SAN (Storage Area Network) formed using a Fibre Channel so as to send data to and receive data from the storage apparatus 100. The host computer 300 saves data used for the task processing in the storage apparatus 100 and reads such data out of the storage apparatus 100.

The control unit 110a includes a CPU (Central Processing Unit) 111a, a cache memory 112a, and device adapters 113c and 113d.

The CPU 111a executes processes in accordance with an OS (Operation System) or the like to perform various controlling operations. In addition, the control unit 110a manages resources in the cache memory 112a, the storage devices 1201a, 1201b, 1201c, and 1201d and other storage devices included in the storage pool 120, and the channel adapters 130c and 130d.

The cache memory 112a stores control data which is necessary for the CPU 111a to control the operation of the storage apparatus 100. In addition, the cache memory 112a temporarily stores input/output data which is written into and read out of each storage device included in the storage pool 120.

The device adapters 113c and 113d control connection with each storage device included in the storage pool 120.

The control units 110a and 110b are connected with each other via a bus 140. Control information and data are communicated between the control units 110a and 110b via the bus 140. The control unit 110b has the same configuration as the control unit 110a and hence description thereof will be omitted.

The storage pool 120 includes a plurality of storage devices such as, for example, the storage devices 1201a to 1201d and the like and stores data into RAID groups which are logical storage areas to be set in RAID that have been set in the storage areas of the above mentioned storage devices.

The storage devices 1201a to 1201d and other storage devices included in the storage pool 120 are hard disk drives that may configure RAID and store data of a user of a system which has been sent from the host computer 300 or backup data. The data of the user of the system and the backup data may not necessarily be stored in one hard disk and may be stored across a plurality of hard disks. In addition, data and backup data of a plurality of users may be stored in one hard disk. The storage devices 1201a to 1201d may be nonvolatile semiconductor memories such as, for example, SSDs (Solid State Drives) or other storage media that store data.

The channel adapters 130c to 130f control connection between the host computer 300 and the control units 110a and 110b. For example, the channel adapter 130c receives a request from the host computer 300 and controls connection of the host computer 300 with the control unit 110a. Each of the control units 110a and 110b is connectable with a plurality of (two in FIG. 2) channel adapters. The control unit 110a is connectable with channel adapters 130c and 130d, and the control unit 110b is connectable with channel adapters 130e and 130f. That is, for example, the control unit 110a is connected with two different channel adapters 130c and 130d so as to implement a redundancy configuration.

Although communication between each of the channel adapters 130c to 130f and the host computer 300 is established by connecting each channel adapter with the host computer 300 via SAN configured using Fibre Channel, the channel adapters 130c to 130f and the host computer 300 may be connected using other connection systems than Fibre Channel. The storage apparatus 100 may be provided at a position remote from the host computer 300 and communication may be established between each of the channel adapters 130c to 130f and the host computer 300 via a common carrier leased line or a VPN (Virtual Private Network).

Although in FIG. 2 two control units 110a and 110b are illustrated and the device adapters 113c to 113f and the channel adapters 130c to 130f are illustrated such that two adapters are allocated to each of the control units 110a and 110b, the number of respective elements may be optional.

Processing functions of the second embodiment may be implemented using the above-described hardware configuration.

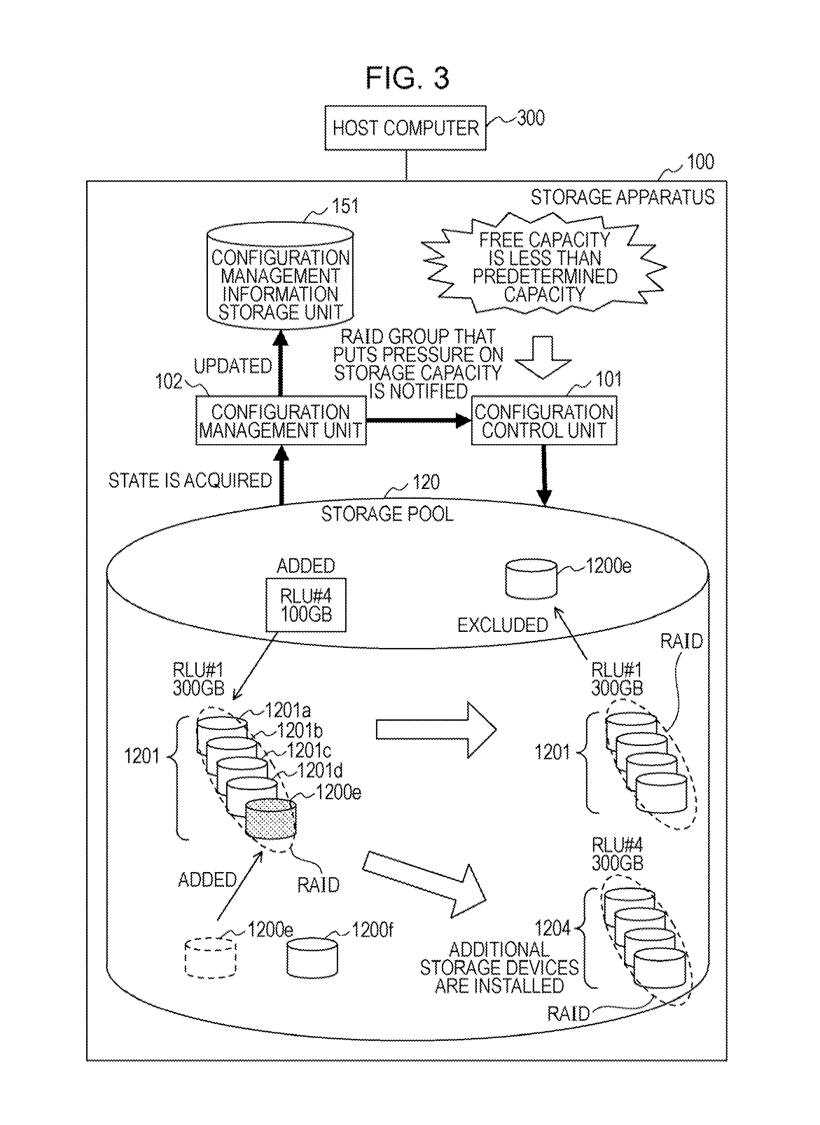

FIG. 3 is a block diagram illustrating functions of the storage apparatus according to the second embodiment. The storage apparatus 100 according to the second embodiment is connected with the host computer 300 via LAN. The storage apparatus 100 includes a configuration control unit 101, a configuration management unit 102, the storage pool 120, and a configuration information storage unit 151. The storage pool 120 includes spare storage devices 1200e and 1200f and a RAID group 1201 (RLU#1). The RAID group 1201 is initially set in RAID configured using storage devices 1201a, 1201b, 1201c and 1201d. The configuration control unit 101 adds a RAID group 1204 (RLU#4) to the storage pool 120 by setting it in the RAID configured using the storage devices 1201a, 1201b, 1201c and 1201d in which the RAID group 1201 has been set.

When the storage capacity of the storage pool 120 has been reduced, for example, when a remaining capacity of the storage pool 120 has been reduced to an amount less than a certain amount (for example, 10% of a maximum storage capacity), the configuration control unit 101 requests the configuration management unit 102 to notify it of the RAID group (for example, the RAID group 1201) that uses the storage capacity the most. The configuration control unit 101 causes the configuration management unit 102 to notify it of the RAID group that uses the storage capacity the most. Then, the configuration control unit 101 adds the spare storage device 1200e to the storage devices 1201a, 1201b, 1201c and 1201d that configure the RAID in which the RAID group 1201 indicated by the configuration management unit 102 is set. Subsequently, the configuration control unit 101 uses an increment of the storage capacity obtained by adding the spare storage device 1200e and sets the RAID group 1204 in the storage devices that configure the RAID in which the RAID group 1201 is set, thereby adding the RAID group 1204 to the storage pool 120.

Subsequently, when storage devices are increased in the storage pool 120, the configuration control unit 101 excludes the spare storage device 1200e, which has been added to the storage devices that configure the RAID group 1201 indicated by the configuration management unit 102, from the storage devices that configure the RAID group 1201, newly sets RAID in the increased storage devices, and moves the RAID group 1204 which has been added upon addition of the spare storage device 1200e to the RAID set in the increased storage devices.

Here, the configuration control unit 101 acquires configuration management information stored in the configuration management information storage unit 151 via the configuration management unit 102 and reads data in units of stripes out of the RAID group 1201 from which the spare storage device 1200e is not yet excluded. A stripe is a set of data blocks in a RAID group and includes one data block of each storage device included in RAID and corresponding parity data generated from each data block. Then, the configuration control unit 101 reconfigures the stripes of the RAID group 1201 in a buffer included in the configuration control unit 101 in accordance with the RAID configuration of storage devices in which the RAID group 1201 will be set after exclusion of the spare storage device 1200e based on the acquired configuration management information. Then, the configuration control unit 101 executes a rewriting process of writing the reconfigured stripes into areas which are allocated thereto in the RAID group 1201 from which the spare storage device 1200e has been excluded. In such case, the configuration control unit 101 writes the stripes of the RAID group 1201 into the RAID group 1201 which is set in the RAID from which the spare storage device 1200e has been excluded in order starting from the end address of the storage area in the RAID group 1201. Writing the stripes of the RAID group 1201 in order starting from the end address of each storage area in the RAID group 1201 as described above prevents, when data is rewritten, the data being erroneously written over data reconfiguration of which is not yet completed.

The configuration control unit 101 moves the data of the RAID group 1204 into the RAID configured using the increased storage devices. Here, the configuration control unit 101 reads the stripes of the RAID group 1204 out of the storage devices which have been set together with the RAID group 1201, reconfigures the read stripes of the RAID group 1204 in accordance with the RAID configuration of the increased storage devices based on the configuration management information which has been acquired via the configuration management unit 102, writes the reconfigured stripes into the increased storage devices, and deletes the data of the RAID group 1204 which is stored in the storage devices that store the data of the RAID group 1201, thereby moving the data of the RAID group 1204 into the RAID which is configured using the increased storage devices. With the above mentioned operations, only the RAID group 1201 will be again set in the storage devices that store the data of the RAID group 1201.

The configuration management unit 102 acquires the RAID configurations of the storage devices and the states of the RAID groups in the storage pool 120 to update the configuration management information which is stored in the configuration management information storage unit 151. The configuration management unit 102 notifies the configuration control unit 101 of the updated configuration management information in response to a request from the configuration management unit 101. The configuration management unit 102 notifies the host computer 300 of information indicating the RAID configurations of the storage devices and the states of the RAID groups in the storage pool 120.

Further, the configuration management unit 102 acquires the configuration management information stored in the configuration management information storage unit 151 and specifies the RAID group that uses storage capacity the most based on the acquired configuration management information. Then, the configuration management unit 102 notifies the configuration control unit 101 of the specified RAID group.

The configuration management information storage unit 151 stores configuration management information indicating the configuration of RAID included in the storage pool 120. The configuration control unit 101 acquires the configuration management information which is stored in the configuration management information storage unit 151 via the configuration management unit 102 and manages the configuration of RAID in the storage pool based on the acquired configuration management information.

The RAID group 1201 is a logical storage area which is set in the RAID configured using the storage devices 1201a, 1201b, 1201c and 1201d. Each of the storage devices 1201a, 1201b, 1201c and 1201d includes a storage area in which data may be stored. The storage apparatus 100 stores data sent from the host computer 300 into the RAID group 1201 and sends the host computer 300 the data stored in the RAID group 1201 in response to a request from the host computer 300. Likewise, the RAID group 1204 and other RAID groups included in the storage pool 120 are logical storage areas set in a plurality of (for example, four) storage devices. The storage devices in RAID in which the RAID group 1204 and other RAID groups are set include storage areas in which data may be stored.

Although in FIG. 3, the RAID in which the RAID groups 1201 and 1204 are set include four storage devices, the number of storage devices included in RAID is not limited to four and RAID in which the RAID groups 1201 and 1204 or other RAID groups are set in the storage pool 120 may include an arbitrary number of storage devices. In addition, the number of storage devices may be different between RAIDs in which the RAID groups 1201 and 1204 or other RAID groups are set in the storage pool 120.

The spare storage devices 1200e and 1200f are storage devices used as spares, include storage areas in which data may be stored and are normally on standby in the power-on state without belonging to any RAID. When a fault has occurred in a storage device included in RAID in which the RAID group 1201 is set or in a storage device included in another RAID, the spare storage device 1200e or 1200f is incorporated into the RAID to which the fault-occurred storage device has ever belonged in place of the fault-occurred storage device. The spare storage devices 1200e and 1200f may be on standby in the power-off state and the power may be turned on in use.

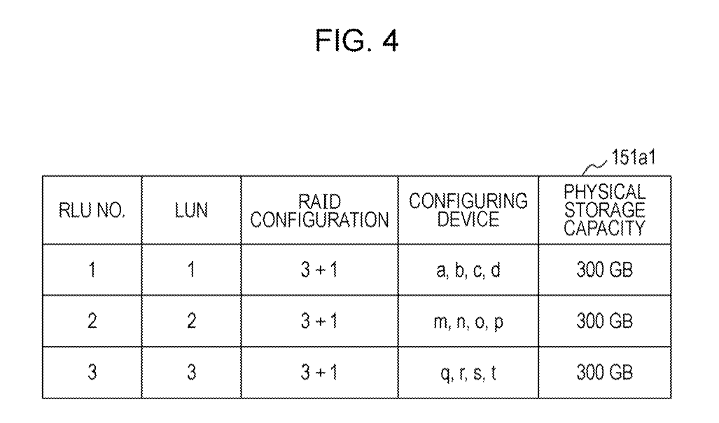

FIG. 4 is a diagram illustrating a configuration management table in the second embodiment. A configuration management table 151a1 illustrated in FIG. 4 is stored in the configuration management information storage unit 151 included in the storage apparatus 100 and is managed using the configuration management unit 102 included in the storage apparatus 100. The configuration management table 151a1 stores configuration management information indicating the configurations of RAID in the storage pool 120 included in the storage apparatus 100.

In the configuration management table 151a1, “RLU No.”, “LUN”, “RAID Configuration”, “Configuring Device”, and “Physical Storage Capacity” are prepared as items. In the configuration management table 151a1, pieces of information horizontally arranged are associated with one another as configuration management information.

“RLU No.” indicates a number which is allocated to each RAID group in order to uniquely indentify each RAID group set in the storage apparatus 100. In FIG. 4, the RLU No. “1” indicates the RAID group 1201 (RLU#1) in the second embodiment. Likewise, the RLU Nos. “2” and “3” respectively indicate the RAID group 1202 (RLU#2) and a RAID group 1203 (RLU#3) in the second embodiment.

“LUN” (Logical Unit Number) indicates a number which is allocated in order to uniquely identify a part obtained by logically dividing the storage area in each RAID group.

“RAID Configuration” indicates the RAID configuration of RAID in which each RAID group is set. In the storage apparatus 100 according to the second embodiment, each RAID group is set in RAID which is configured by the RAID 5 system. The RAID in which each RAID group is set is operated based on RAID 5 (3+1) (RAID 5 in which each stripe includes three data blocks and one parity data block) in a normal state in which the spare storage device 1200e or the like is not used, and is operated based on RAID 5 (4+1) (RAID 5 in which each stripe includes four data blocks and one parity data block) when the spare storage device 1200e or the like is added.

The RAID in which each RAID group is set is not limited to the above and each RAID group may be set in RAID which is configured based on an arbitrary RAID system such as, for example, RAID 6, RAID 1+0, or the like. In addition, the RAID may be operated using an arbitrary stripe configuration such as RAID 5 (2+1), RAID 5 (7+1), or the like.

“Configuring Device” indicates a storage device that configures RAID in which each RAID group is set.

“Physical Storage Capacity” indicates a physical storage capacity of each RAID group. The physical storage capacity indicates the amount of data which is allowed to be stored with respect to data sent from the host computer 300. In the second embodiment, the storage capacity of each storage device is, for example, 100 GB (Giga Bytes).

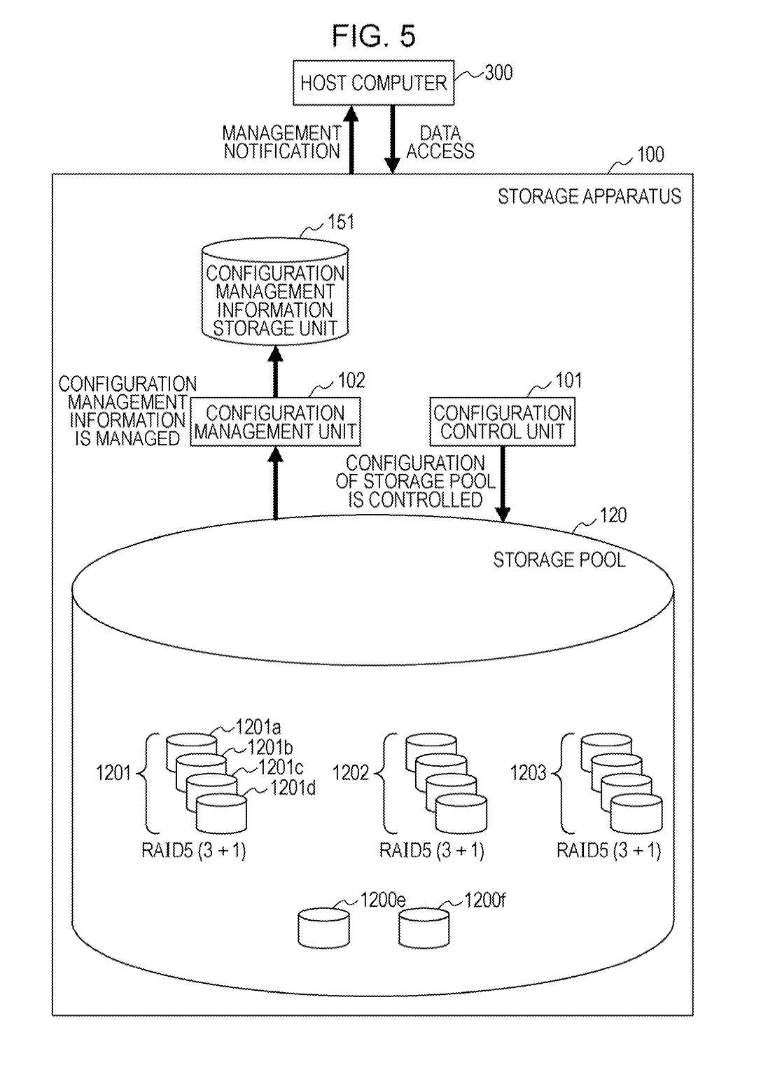

The configuration management table 151a1 illustrated in FIG. 4 indicates the configuration of the RAID in the storage apparatus 100 in a normal state which will be described with reference to FIG. 5. Each RAID group is set in three storage devices that store three data blocks and one storage device that stores one parity data block as indicated by “RAID Configuration” in the configuration management table 151a1. In addition, each RAID group is set in four different storage devices as indicated by “Configuring Device” in the configuration management table 151a1. Further, as indicated by “Physical Storage Capacity” in the configuration management table 151a1, a 300-GB physical storage capacity is allocated to each RAID group.

FIG. 5 is a diagram illustrating a configuration of RAID in a normal state in the second embodiment. The storage apparatus 100 according to the second embodiment is connected with the host computer 300 as illustrated in FIG. 5, accepts data access from the host computer 300, sends the host computer 300 data which has been requested from the host computer 300, and stores data sent from the host computer 300. In addition, the storage apparatus 100 sends the host computer 300 a management notification that the configuration of the storage pool 120 has been changed. Accordingly, data may be read out of the host computer 300 and may be written into the storage apparatus 100 regardless of a change in the configuration of the storage pool 120.

As illustrated in FIG. 5, the storage apparatus 100 according to the second embodiment includes the configuration control unit 101, the configuration management unit 102, the storage pool 120 and the configuration management information storage unit 151. The storage pool 120 includes the RAID groups 1201, 1202, and 1203, and the spare storage devices 1200e and 1200f.

It is supposed that the storage apparatus 100 has a sufficient amount of remaining storage capacity in the storage pool 120 (for example, not more than 90% of the storage capacity is used). In this case, the RAID group 1201 is set in the storage devices 1201a, 1201b, 1201c and 1201d, and RAID 5 (3+1) is configured using the storage devices 1201a, 1201b, 1201c and 1201d. Likewise, each of the RAID groups 1202 and 1203 is set in four storage devices, and RAID 5 (3+1) is configured using the four storage devices. The spare storage devices 1200e and 1200f are on standby to be used in occurrence of a fault in a storage device in a state in which the power are turned on. The spare storage devices 1200e and 1200f are used immediately after added to a RAID group in which a fault has occurred as components for hot swapping.

In the second embodiment, it is supposed that each of the storage devices 1201a, 1201b, 1201c, and 1201d, other storage devices in which the RAID groups 1202 and 1203 are set, and the spar storage devices 1200e and 1200f has a storage capacity of 100 GB.

The storage apparatus 100 according to the second embodiment is allowed to temporarily increase the physical storage capacity of the RAID group in the storage pool 120 by adding the spare storage device 1200e to storage devices on which the RAID group is set when the remaining capacity of the storage pool 120 has been reduced.

In the storage apparatus 100 according to the second embodiment, the configuration control unit 101 controls the configuration of each of the RAID groups 1201 to 1203 in the storage pool 120. When the configuration of one of the RAID groups 120 to 1203 has been changed as a result of control executed using the configuration control unit 101, the control management unit 102 updates the configuration control information stored in the configuration management information storage unit 151.

As described above, although in the second embodiment, it is supposed that all the storage devices 1201a, 1201b, 1201c, and 1201d, other storage devices on which the RAID groups 1202 and 1203 are set, and the spare storage devices 1200e and 1200f are set to have the same storage capacity (100 GB), the storage capacity of each storage device is not limited to the above and storage devices of different storage capacities may be used in a mixed state.

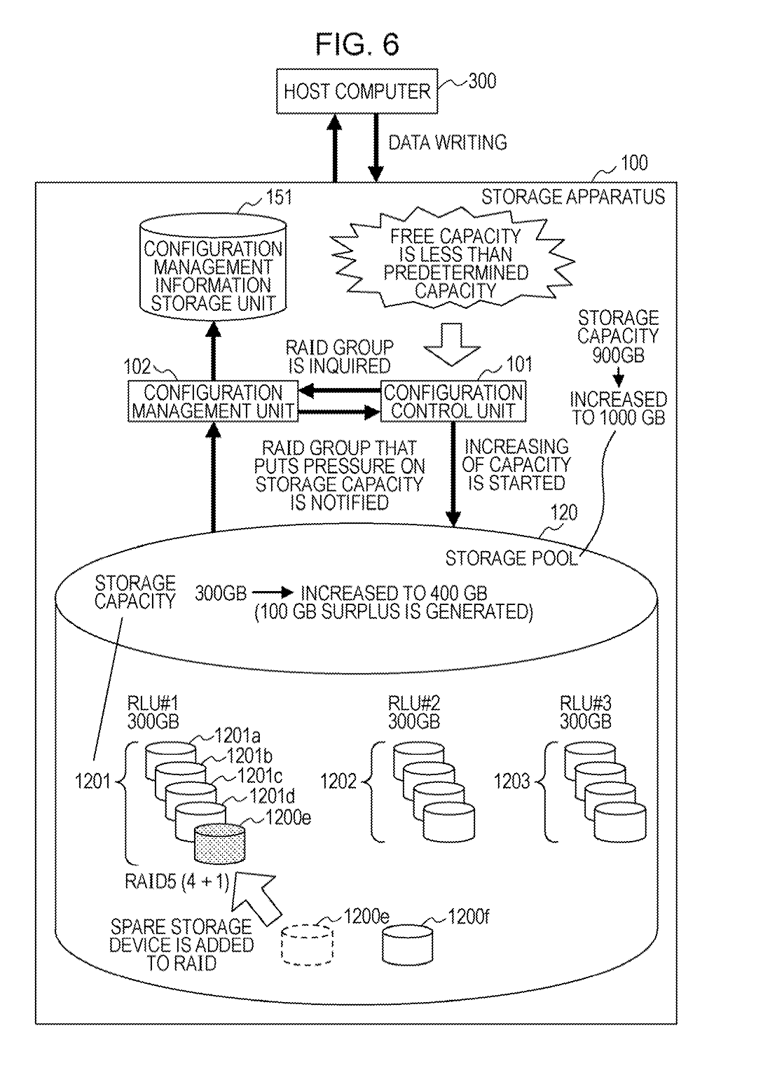

FIG. 6 is a diagram illustrating an operation of adding a spare storage device in the second embodiment. When the amount of data written into the storage pool 120 has been increased and hence the free space of the storage pool 120 has been reduced, the storage apparatus 100 according to the second embodiment temporarily adds the spare storage device 1200e to the storage devices in the RAID in which the RAID group 1201 is set, reconfigures the RAID group 1201, and increases the available physical storage capacity of the storage pool 120.

Next, the operation that the storage apparatus 100 according to the second embodiment adds the spare storage device 1200e to the storage devices in the RAID in which the RAID group 1201 is set, reconfigures the RAID group 1201, and increases the storage capacity of the RAID group 1201 will be described with reference to FIG. 6.

When a request for data writing has been received from the host computer 300 and the amount of the free space has been reduced to a predetermined amount or less, the configuration control unit 101 inquires of the configuration management unit 102 about the amount of data stored in each RAID group which is set in the storage pool 120. The configuration management unit 102 acquires the amount of data stored in each RAID group with reference to the configuration management information stored in the configuration management information storage unit 151 in response to the inquiry from the configuration control unit 101 and notifies the configuration control unit 101 of the RAID group that uses the storage capacity the most. In such case, a RAID group having the highest ratio of using data to the total physical storage capacity of that RAID group may be selected as the RAID group that uses the storage capacity the most. In FIG. 6, it is supposed that the RAID group 1201 (RLU#1) uses the storage capacity of the storage pool 120 the most.

The configuration control unit 101 that has received a notification that the RAID group that uses the storage capacity of the storage pool the most is the RAID group 1201 from the configuration management unit 102 adds the spare storage device 1200e to the storage devices in the RAID in which the RAID group 1201 is set, and changes its RAID configuration. As a result, the RAID configuration of the RAID in which the RAID group 1201 is set is changed from RAID 5 (3+1) to RAID 5 (4+1). Owing to the above mentioned operation, the physical storage capacity of the RAID group 1201 is increased from 300 GB before addition of the spare storage device 1200e to 400 GB after addition of the spare storage device 1200e, and 100 GB corresponding to the storage capacity of the spare storage device 1200e is added as an increment. In addition, the storage capacity of the entire storage pool 120 is increased from 900 GB before addition of the spare storage device 1200e to 1000 GB after addition of the spare storage device 1200e with increasing the physical storage capacity of the RAID group 1201.

Although in the second embodiment, the spare storage device 1200e is added to the RAID of the RAID group 1201 (to the storage devices in the RAID in which the RAID group 1201 is set) that uses the storage capacity of the storage pool 120 the most, the RAID group to which the spare storage device is added is not limited to the RAID group 1201 and a RAID group to which the spare storage device 1200e will be added may be selected in accordance with the state of each RAID group. In such case, for example, a RAID group having the highest ratio of usage in storing data to a maximum physical storage capacity of each RAID group may be selected as the RAID group to which the spare storage device 1200e will be added.

In addition, although in the second embodiment, one spare storage device, that is, the spare storage device 1200e is temporarily added to the RAID of the RAID group 1201, the number of spare storage devices to be added is not limited to one and two spare storage devices such as, for example, the spare storage devices 1200e and 1200f or the like may be added, or two or more spare storage devices may be added. When a plurality of spare storage devices are temporarily added as described above, the spare storage devices may be added to RAID in which a plurality of different RAID groups are set (for example, one spare storage device may be added to each of the RAID groups 1201 and 1202). In such case, a standard for selecting a plurality of RAID groups to which spare storage devices are added may be set in order in which a spare storage device is added to two RAID groups that use the storage capacity of the storage pool 120 more than other RAID groups. Accordingly, RAID groups the storage capacity of which is increased by addition of the spare storage devices 1200e and 1200f are selected.

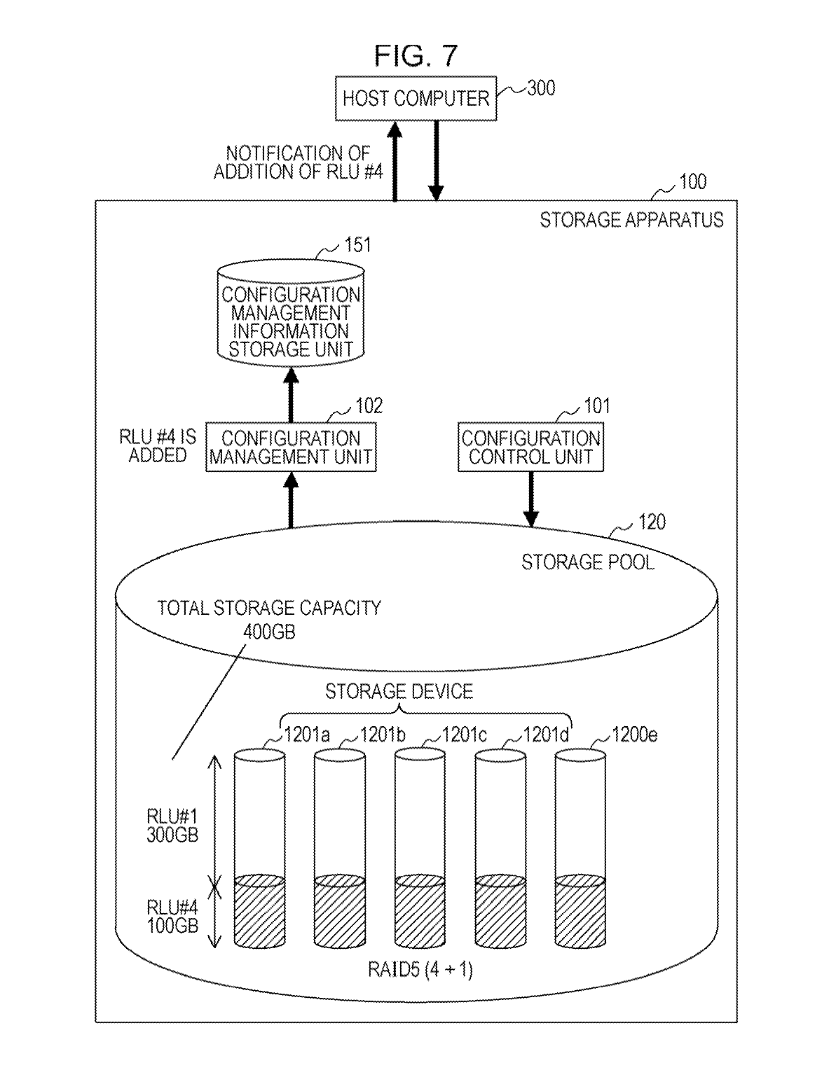

FIG. 7 is a diagram illustrating an operation of adding a RAID group in the second embodiment.

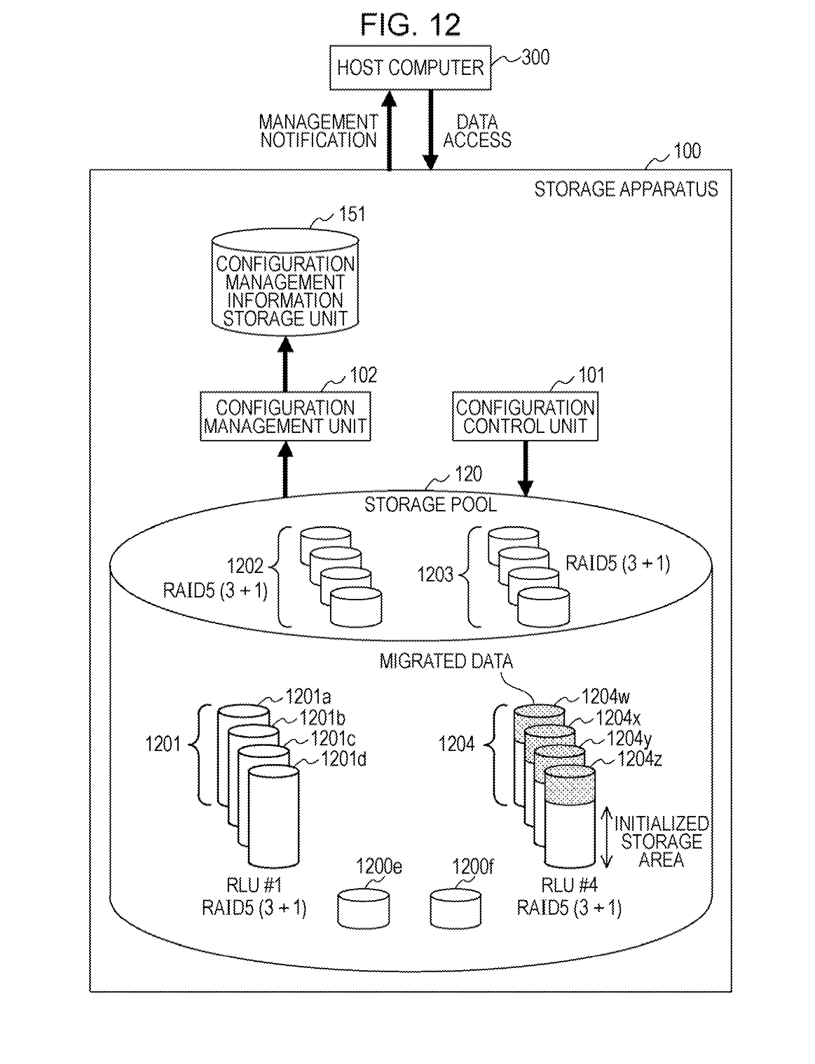

The storage apparatus 100 according to the second embodiment adds and sets the RLU#4 which is a new RAID group (the RAID group 1204 which will be described later with reference to FIG. 12) on the storage devices on which the RAID group 1201 the storage capacity of which has been increased by addition of the spare storage device 1200e described with reference to FIG. 6 is set.

Next, the operation that the storage apparatus 100 according to the second embodiment adds the RLU#4 to the storage devices in the RAID in which the RAID group the storage capacity of which has been increased is set will be described with reference to FIG. 7.

As described above, the RAID group 1201 in the storage pool 120 is set in the storage devices 1201a, 1201b, 1201c, 1201d, and the added spare storage device 1200e. The RAID group 1201 is configured as RAID 5 (4+1) having a storage capacity of 400 GB.

On the other hand, since 300 GB is set for the RLU#1 which is set to the RAID group 1201 as its storage capacity, the RAID group 1201 may have a free space of 100 GB.

The configuration control unit 101 sets the RLU#4 having a storage capacity of 100 GB for the 100 GB free space of the storage device on which the RAID group 1201 is set. That is, the RLU#4 is set for the RAID group 1201 having the redundancy of RAID 5 (4+1) in which the RLU#1 has been set. For example, when a fault has occurred in the spare storage device 1200e in a state in which the RLU#4 is set only for the spare storage device 1200e, the data in the RLU#4 may be destroyed. On the other hand, in the second embodiment, the RLU#4 is set for the RAID group 1201 having the redundancy of RAID 5 (4+1) and hence destruction of the data in the RLU#4 may be avoided.

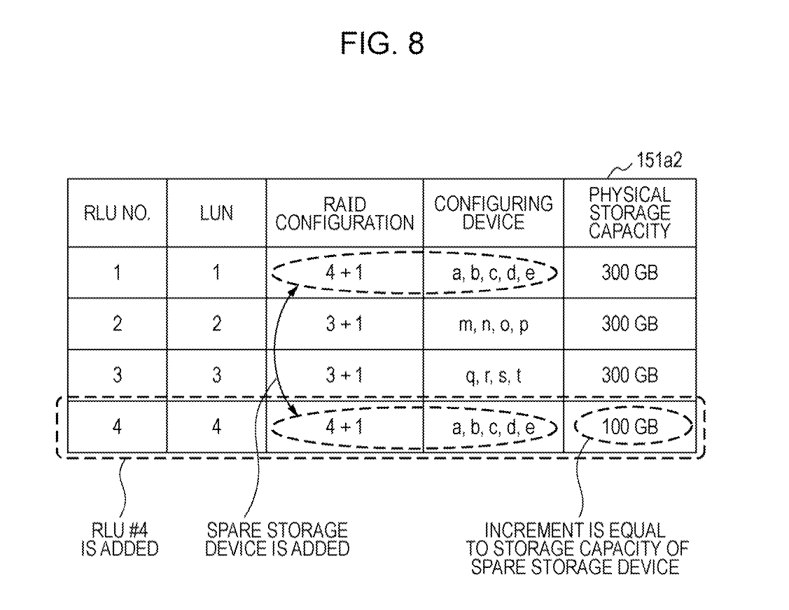

The configuration management unit 102 updates the configuration management information stored in the configuration management information storage unit 151 based on addition of the RLU#4 to the storage pool 120 by the configuration control unit 101. As a result, the total physical storage capacity of the storage pool 120 is changed from 900 GB to 1000 GB as will be described later with reference to FIG. 8.

In addition, the storage apparatus 100 notifies the host computer 300 of addition of the RLU#4. Owing to the above mentioned operations, the host computer 300 is allowed to read data out of the added RLU#4 and to write data into it, that is, the available storage capacity may be increased. As a result, it is allowed to temporarily compensate for shortage of the storage capacity of the storage apparatus 100 by temporarily increasing the storage capacity of the storage pool 120 for a time period until storage devices will be increased in future, for example, in periodic maintenance or the like.

In addition, an increment of the storage capacity which is obtained by addition of the spare storage device 1200e is set as the increment obtained by addition of the RLU#4. Accordingly, it is allowed to cope with the situation simply by adding a RAID group to the storage pool 120 without changing the RAID group (for example, the RAID group 1201 or the like) that the host computer 300 is currently using.

FIG. 8 is a diagram illustrating a configuration management table indicating a state in which a spare storage device and a RAID group have been added in the second embodiment. A configuration management table 151a2 illustrated in FIG. 8 is updated so as to indicate the storage pool 120 of the storage apparatus 100 in a state in which the spare storage device 1200e is added to the storage devices on which the RAID group 1201 has been set and the RLU#4 is also added as described above with reference to FIG. 7. In the above mentioned situation, in the storage apparatus 100, the RLU#4 is also set in the storage devices (configuring devices a, b, c, d and e in the configuration management table 151a2) on which the RLU#1 is set for the RAID group 1201 as indicated by “RLU No.” and “Configuring Device” in the configuration management table 151a2. In the example illustrated in FIG. 8, it is supposed that the configuring devices “a”, “b”, “c”, and “d” in the configuration management table 151a2 indicate the storage devices 1201a, 1201b, 1201c and 1201d. It is also supposed that the configuring device “e” in the configuration management table 151a2 indicates the spare storage device 1200e. The stripe which will be stored in the RAID group 1201 as a result of addition of the spare storage device 1200e to the storage devices on which the RLU#1 is set is updated so as to include four data blocks and one parity data block as indicated by “RAID Configuration” in the configuration management table 151a2. In addition, as indicated by “Physical Storage Capacity” in the configuration management table 151a2, a physical storage capacity of 100 GB which is an increment obtained by addition of the spare storage device 1200e to the storage devices in the RAID group 1201 is allocated to the RLU#4.

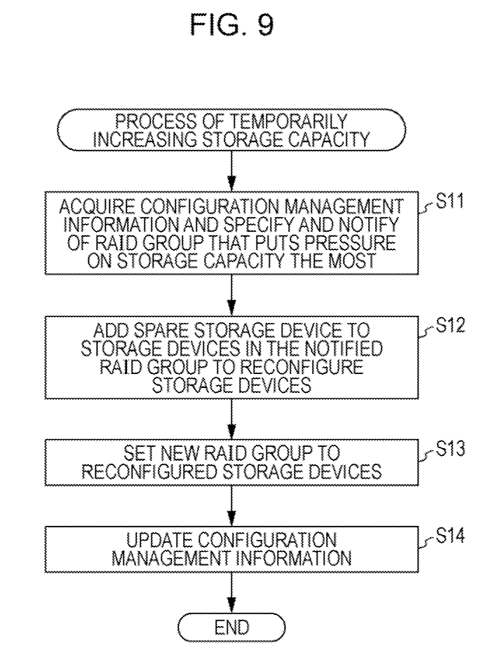

FIG. 9 is a flowchart illustrating a process of temporarily increasing storage capacity in the second embodiment. When the amount of the free space in the storage pool 120 has been reduced to a predetermined amount (for example, 10% of a current maximum storage capacity of the storage pool 120) or less, the storage apparatus 100 according to the second embodiment executes a storage-capacity-temporarily-adding process of adding the spare storage device 1200e to the storage devices in the RAID group 1201. Next, the storage-capacity-temporarily-adding process illustrated in FIG. 9 will be described along steps in the flowchart.

[S11] The configuration management unit 102 refers to the configuration management information stored in the configuration management information storage unit 151 to specify a RAID group that uses the storage capacity of the storage pool 120 the most. In FIG. 9, a RAID group currently uses the storage capacity most may be specified as the RAID group that uses the storage capacity of the storage pool 120 the most. Then, the configuration management unit 102 notifies the configuration control unit 101 of the specified RAID group.

[S12] The configuration control unit 101 adds a spare storage device to the storage devices on which the RAID group which has been notified as the specified RAID group at step S11 is set to reconfigure the RAID.

[S13] The configuration control unit 101 adds and sets a new RAID group on the storage devices the RAID of which has been reconfigured. Here, the newly added RAID group is formatted such that data is allowed to be read out of the newly added RAID group and to be written into it. As a result, the physical storage capacity of the storage pool 120 is increased. In such case, the RAID may be reconfigured using, for example, an LDE (Logical Device Expansion) function.

[S14] The configuration management unit 102 updates the configuration management information stored in the configuration management information storage unit 151 based on the processes executed at step S12 and step S13. As a result, addition of the RAID group which has been newly added at step S12, the state of the added RAID group, and an increase in the storage capacity of the storage pool 120 are reflected on the configuration management information.

Although in the storage-capacity-temporarily-increasing process in the second embodiment, the configuration management information is updated at step S14 based on results of execution of the processes at step S12 and step S13 after execution of the processes at step S12 and step S13 has been completed, the order in which the processes are executed is not limited to the above and the configuration management information may be updated every time execution of each of the processes at step S12 and step S13 is completed.

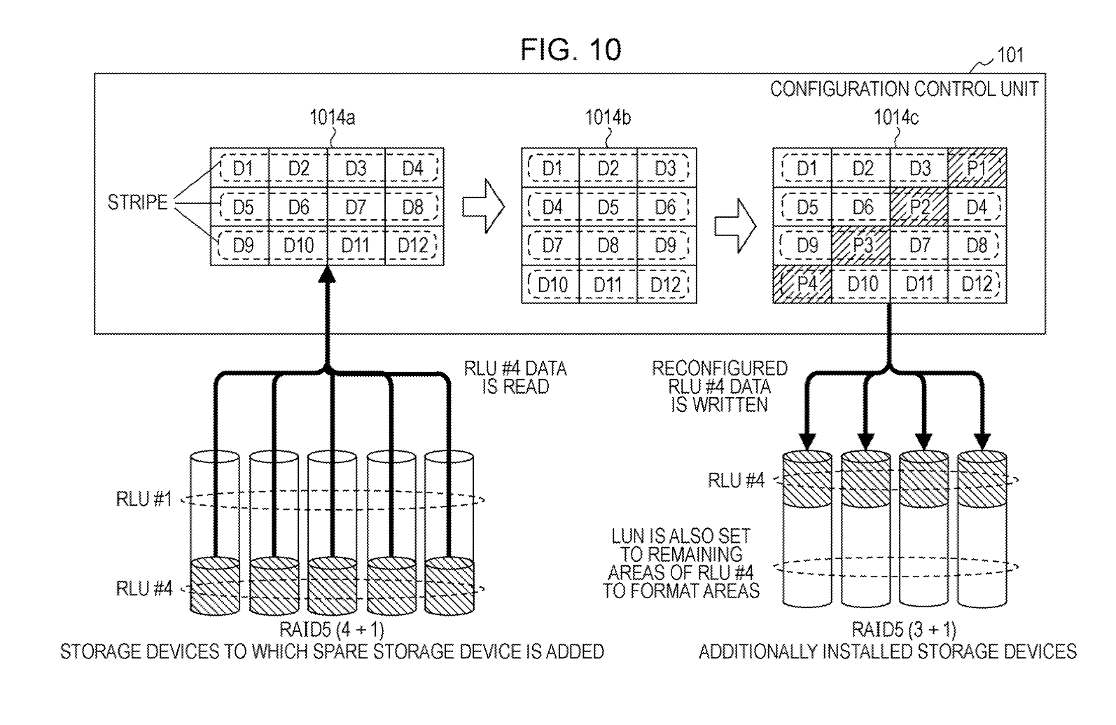

FIG. 10 is a diagram illustrating an operation of moving data of an added RAID group into increased storage devices in the second embodiment. Although in the second embodiment, the RLU#4 which has been described with reference to FIG. 7 is added to the storage pool 120, the storage capacity is increased only by the amount corresponding to the storage capacity of the added spare storage device 1200e, and hence it may sometimes occur that a fundamental problem of shortage of the storage capacity of the storage apparatus 100 is not solved simply by adding the spare storage device. In addition, the spare storage device 1200e which is to be originally used only as a spare is used in the RLU#1 (RAID group 1201) and the RLU#4 for a time period until the RAID group moving operation is performed. It may be desirable to exclude the spare storage device 1200e from the RAID as soon as possible to ensure again the redundancy of the storage devices in the storage pool 120.

When the storage devices have been increased after addition of the RLU#4 which has been described with reference to FIG. 7, the storage apparatus 100 according to the second embodiment moves the data of the RLU#4 into the RAID configured using the increased storage devices and excludes the spare storage device 1200e from the storage devices on which the RAID group 1201 is set, thereby reconfiguring the storage devices on which the RAID group 1201 is set. It is supposed that the RAID configuration of the increased storage devices is RAID 5 (3+1).

Next, the operation that the storage apparatus 100 according to the second embodiment moves the data of the RLU#4 which is set in the RAID of the storage devices which are the same as those in the RLU#1 into the RAID which is set in the increased storage devices will be described with reference to FIG. 10.

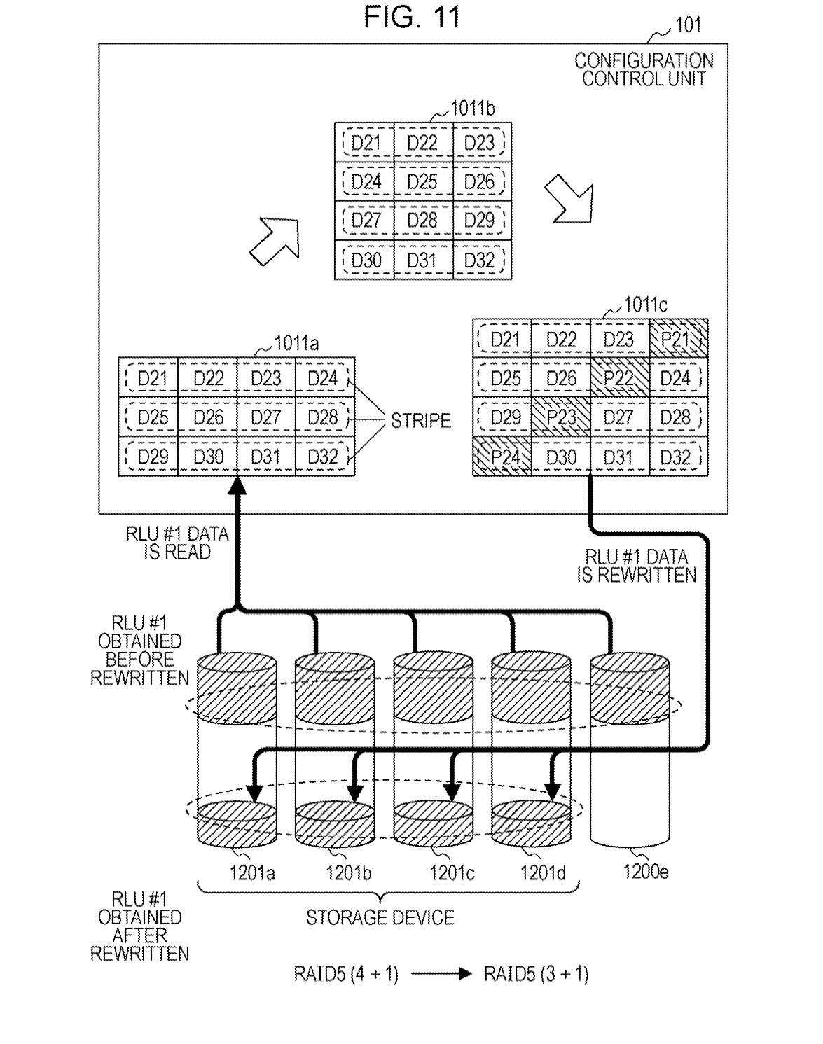

The configuration control unit 101 inquires of the configuration management unit 102 about the configuration management information stored in the configuration management information storage unit 151 to acquire information used for data migration of the RLU#4 and data rewriting into the RLU#1 which will be described later with reference to FIG. 11 such as, for example, data migration destinations into which data of the RLU#1 and the RLU#4 will be moved, logical block addresses, physical addresses, storage device configurations and the like of the data migration destinations.

Next, the configuration control unit 101 reads RLU#4 data 1014a of the RLU#4 out of five storage devices on which the RLU#4 is set in order starting from the top logical block address based on the information which has been acquired based on the inquiry, and stores the read RLU#4 data 1014a into a buffer included in the configuration control unit 101. The parity data of the read data is not used and hence is not read out.

In the above mentioned situation, the configuration of the RLU#1 to which the spare storage device 1200e is added is RAID 5 (4+1) and each stripe includes four data blocks. On the other hand, the configuration of the RAID of the increased storage devices is RAID 5 (3+1) and each stripe includes three data blocks. As described above, it may sometimes occur that the configuration of the RAID of the migration source side storage devices in which the RLU#4 data 1014a is stored is different from that of the RAID of the migration destination side storage devices. In such case, in the second embodiment, the RLU#4 data 1014a which is moved is reconfigured conforming to the configuration of the RAID on the migration destination side. In the example illustrated in FIG. 10, the number of data blocks included in one stripe is changed from 4 in the RAID on the migration source side to 3 in the RAID on the migration destination side.

Although in the example illustrated in FIG. 10, it is supposed that data of three stripes is moved for the convenience of explanation, according to the second embodiment, the number of stripes included in the data which will be moved may be not more than two or may be at least three.

In addition, it is supposed that in the RLU#4 data 1014a, horizontally arrayed blocks indicate data of one stripe, D1 to D12 denote data blocks that the RLU#4 data 1014a holds and vertically arrayed blocks are stored in one storage device. It is also supposed that the same thing also applies to RLU#4 data 1014b and 1014c. As illustrated in the example in FIG. 10, the RLU#4 data 1014a includes four data blocks in each stripe.

Then, the configuration control unit 101 repartitions the blocks D1 to D12 of the RLU#4 data 1014a such that each stripe includes three data blocks as indicated by the RLU#4 data 1014b. In such case, the RLU#4 data 1014a that includes three stripes is repartitioned so as to include four stripes as indicated by the RLU#4 data 1014b.

Then, the configuration control unit 101 generates parity data P1 to P4 for the respective stripes in the RLU#4 data 1014b and incorporates the generated parity data P1 to P4 into the corresponding stripes to generate data that includes three data blocks and one parity data block in each stripe as indicated by the RLU#4 data 1014c. In such case, the stripes are reconfigured by arranging the parity data on the respective stripes so as to avoid concentrative storage of parity data into one storage device.

Then, the configuration control unit 101 writes the RLU#4 data 1014c into the storage devices which have been increased in the storage pool 120. The configuration control unit 101 repeats execution of the above processes until migration of all data blocks in the RLU#4 is completed.

Then, when free areas are present in the increased storage devices, the configuration control unit 101 formats the remaining free areas.

FIG. 11 is a diagram illustrating an operation of rewriting data into storage devices in a RAID group that reduces the storage capacity in the second embodiment. The storage apparatus 100 according to the second embodiment moves the RLU#4 data which has been described with reference to FIG. 10 into the increased storage devices and then excludes the spare storage device 1200e from the storage devices on which the RLU#1 (the RAID group 1201) is set. As a result, the configuration of the storage devices on which the RLU#1 has been set is restored from RAID 5 (4+1) to RAID 5 (3+1). In such case, the storage apparatus 100 reconfigures the stripes of the RLU#1 from the stripes in RAID 5 (4+1) to those in RAID 5 (3+1).

Next, the operation that the storage apparatus 100 according to the second embodiment temporarily reads the data of the RLU#1 out of storage devices and rewrites the read data into the storage devices in order to reconfigure the stripes in the RLU#1 which is set in the storage devices the RAID configuration of which is changed will be described with reference to FIG. 11.

The configuration control unit 101 reads the RLU#1 data 1011a of the RLU#1 out of five storage devices (the storage devices 1201a to 1201d and the spare storage device 1200e) on which the RLU#1 is set in order starting from the end logical block address based on the information acquired in response to the inquiry which has been described with reference to FIG. 10. The RLU#1 data 1011a is read out of the storage devices in order starting from the end logical block address in order to avoid destruction of data which would occur by writing rewritten data over data in a storage area out of which the data is not yet read because data reading and writing operations are performed on the same storage device. Then, the configuration control unit 101 stores the read RLU#1 data 1011a into a buffer included in it. The parity data of the read data is not used and hence is not read out of the storage device.

The RAID configuration of the storage devices 1201a, 1201b, 1201c and 1201d and the spare storage device 1200e on which the RLU#1 with the spare storage device 1200e added is set is RAID 5 (4+1) and each stripe includes four data blocks. On the other hand, the RAID configuration of the storage devices 1201a, 1201b, 1201c and 1201d on which the RLU#1 from which the spare storage device 1200e has been excluded is RAID 5 (3+1) and each stripe includes three data blocks. As described above, the RAID configuration of the storage devices with the RLU#1 before data rewriting is different from that after data rewriting. In the second embodiment, the data of the RLU#1 obtained before data rewriting is reconfigured conforming to the RAID configuration after data rewriting. In the example illustrated in FIG. 11, the number of data blocks included in each stripe is changed from 4 before data rewriting to 3 after data rewriting.

Although in the explanation of the example illustrated in FIG. 11, it is supposed that data of three stripes is rewritten for the convenience of explanation as in the case in the example in FIG. 10, the number of stripes in data to be rewritten may be not more than two and may be at least three.

In addition, it is supposed that in the RLU#1 data 1011a, horizontally arrayed blocks indicate data of one stripe, D21 to D32 denote data blocks that the RLU#1 data 1011a holds and vertically arrayed blocks are stored in one storage device. It is also supposed that the same thing also applies to RLU#1 data 1011b and 1011c. As illustrated in FIG. 11, the RLU#1 data 1011a includes four data blocks in each stripe.

Then, the configuration control unit 101 repartitions the blocks D21 to D32 of the RLU#1 data 1011a such that each stripe includes three data blocks as indicated by the RLU#1 data 1011b. As a result of execution of repartition, the RLU#1 data 1011a that includes three stripes is reconfigured so as to include four stripes as indicated by the RLU#1 data 1011b.

Then, the configuration control unit 101 generates parity data blocks P21 to P24 for the respective stripes in the RLU#1 data 1011b and incorporates the generated parity data blocks P21 to P24 into the corresponding stripes to configure data that includes three data blocks and one parity data block in each stripe as indicated by the RLU#1 data 1011c. The stripes are reconfigured by arranging the parity data on the respective stripes so as to avoid concentrative storage of parity data into one storage device.

Then, the configuration control unit 101 writes the RLU#1 data 1011c into the storage devices 1201a to 1201d on which the reconfigured RLU#1 is set. The configuration control unit 101 repeats execution of the above mentioned processes until migration of all data blocks in the RLU#1 data 1011c is completed. When rewriting of the RLU#1 data has been completed, the configuration control unit 101 excludes the spare storage device 1200e from the RAID and puts it on standby, and sends the configuration management unit 102 a notification that migration of the RLU#4 data, rewriting of the RLU#1 data and exclusion of the spare storage device 1200e have been completed.

Then, the configuration management unit 102 that has received the notification from the configuration control unit 101 updates the configuration management information stored in the configuration management information storage unit 151 based on the contents of the notification.

FIG. 12 is a diagram illustrating a configuration of RAID after increasing storage devices in the second embodiment. The storage apparatus 100 according to the second embodiment includes the configuration control unit 101, the configuration management unit 102, the storage pool 120 and the configuration management information storage unit 151 as illustrated in FIG. 12. The storage pool 120 includes the RAID groups 1201, 1202, and 1203, and the spare storage devices 1200e and 1200f. The RAID group 1201 (RLU#1) is set in the storage devices 1201a to 1201d. In addition, in the example illustrated in FIG. 12, the RAID group 1204 (RLU#4) is added to the storage pool 120. The RAID group 1204 is set in storage devices 1204w to 1204z.

As illustrated in FIG. 12, in the storage apparatus 100, the RAID configurations of the storage devices on which the RAID groups 1201 to 1204 are set are all RAID 5 (3+1). The spare storage devices 1200e and 1200f are on standby for occurrence of a fault in a storage device in a state in which the power is turned on. The spare storage devices 1200e and 1200f are used as components for hot swapping as in the case illustrated in FIG. 5 so as to be used as soon as being added to RAID in which a RAID group is set. As described above, after the storage devices 1204w, 1204x, 1204y, and 1204z have been increased, the redundancy of the storage apparatus 100 is ensured by two spare storage devices 1200e and 1200f.

In the example illustrated in FIG. 12, the spare storage device 1200e is excluded from the RAID of the RAID group 1201 into which data has been rewritten and the RAID configuration of the storage devices is restored to the state illustrated in FIG. 5.

In addition, the RAID group 1204 is set in the storage devices 1204w to 1204z which have been increased in the storage pool 120. In the RAID group 1204, an increment in storage capacity which has been increased when the storage devices 1204w to 1204z have been increased is retained as an initialized free area and as a logical free area of the RAID group 1204.

Although in the second embodiment, the RAID configuration of the storage devices 1201a to 1201d and the spare storage device 1200e from which the RLU#4 data is moved is RAID 5 (4+1) and the RAID configuration of the storage devices 1204w to 1204z into which the RLU#4 data is moved is RAID 5 (3+1), the RAID configurations are not limited to the above and both the migration source and migration destination may have arbitrary RAID configurations.

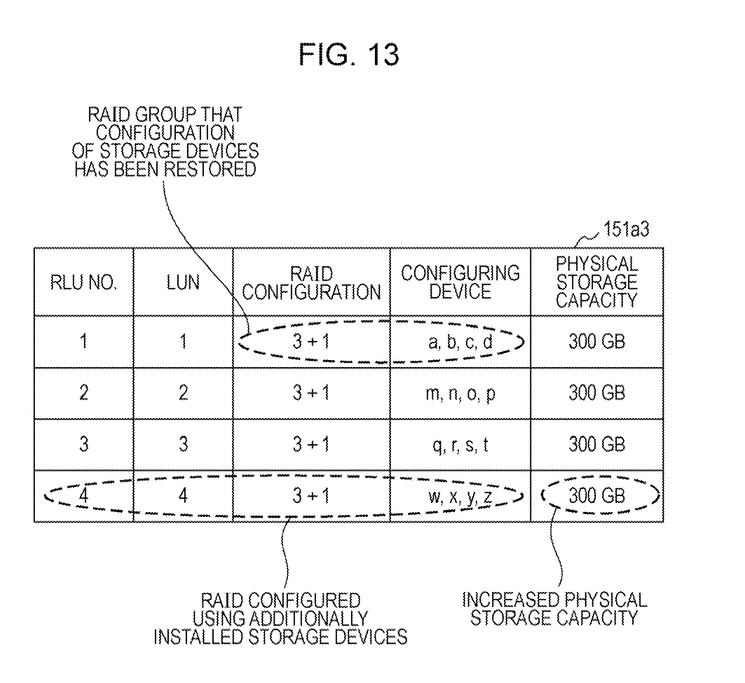

FIG. 13 is a diagram illustrating a configuration management table indicating a state in which storage devices have been increased in the second embodiment. A configuration management table 151a3 illustrated in FIG. 13 is updated so as to indicate the configurations of RAIDs in the storage apparatus 100 in a state in which the storage devices 1204w to 1204z have been increased as described with reference to FIG. 12. In the situation, in the storage apparatus 100, the RLU#4 is set in the increased storage devices 1204w, 1204x, 1204y, and 1204z (respectively corresponding to “w”, “x”, “y” and “z” in “Configuring Device” in the configuration management table 151a3) as indicated by “RLU No.” and “LUN” in the configuration management table 151a3. Since the configuration of the storage devices on which the RLU#1 is set has been restored to the configuration from which the spare storage device 1200e has been excluded, each stripe of the RLU#1 includes three data blocks and one parity data block as indicated by “RAID Configuration” and “Configuring Device” in the configuration management table 151a3. Each stripe of the RLU#4 includes three data blocks and one parity data block as indicated by “RAID configuration and “Configuring Device” in the configuration management table 151a3. In addition, 300 GB which is the physical storage capacity of RAID 5 (3+1) configured using the increased storage devices 1204w, 1204x, 1204y, and 1204z is allocated to the RLU#4 as its physical storage capacity as indicated by “Physical Storage Capacity” in the configuration management table 151a3. As a result, the physical storage capacity of the storage pool 120 is increased.

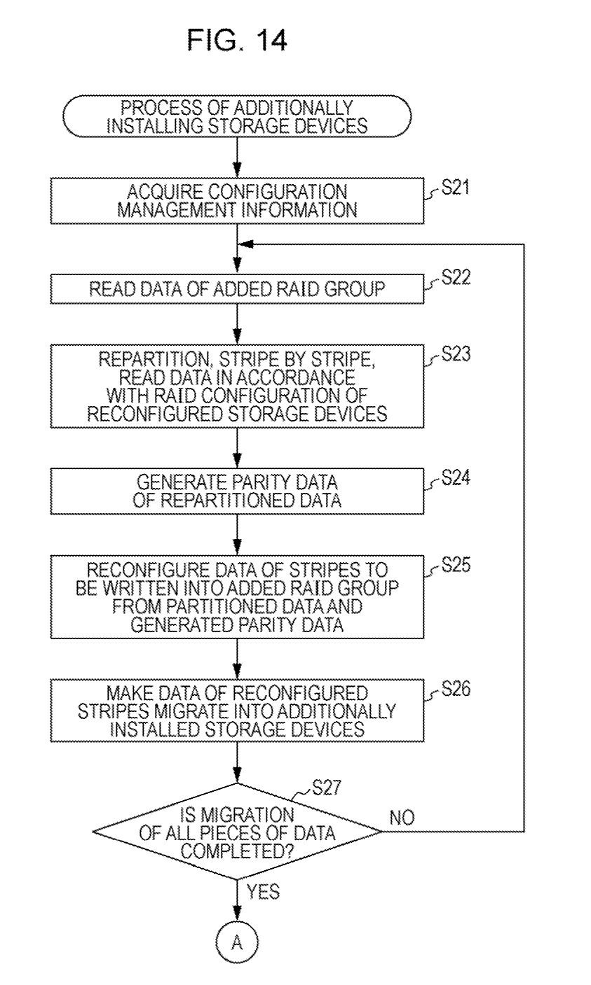

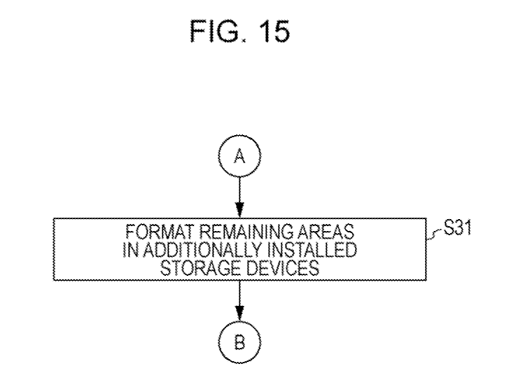

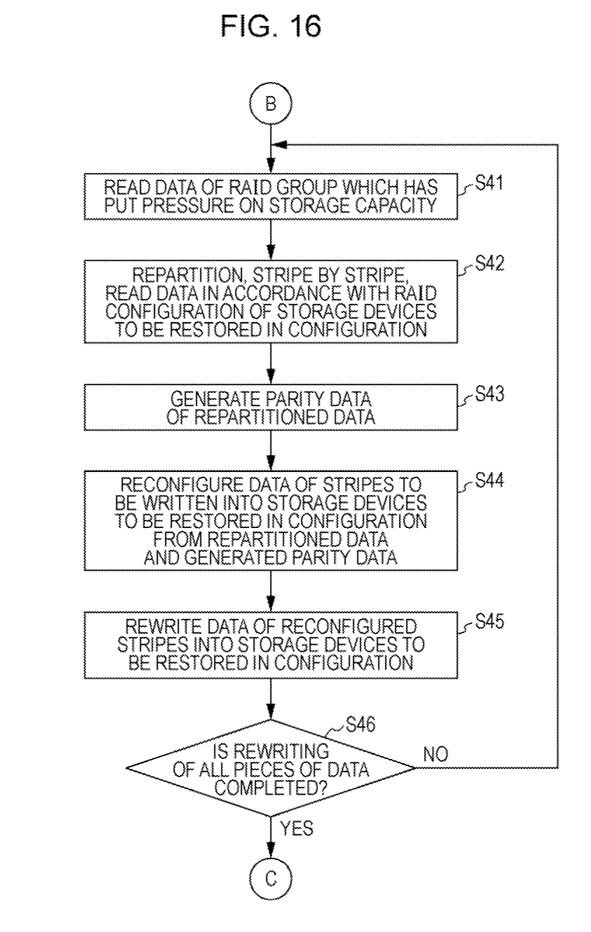

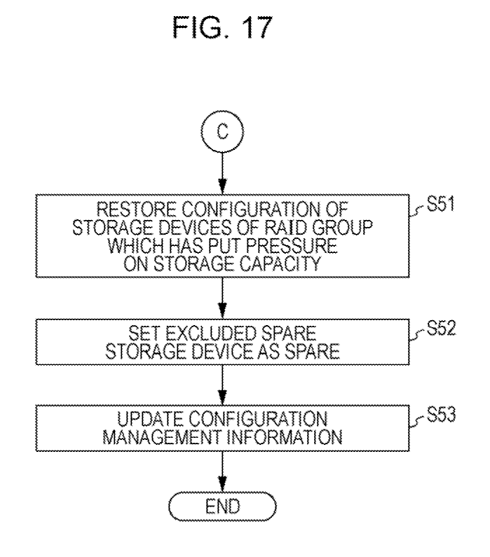

FIG. 14 to FIG. 17 illustrate respective parts of a flowchart illustrating a process of increasing storage devices in the second embodiment. When storage devices which may configure a new RAID have been increased in the storage pool 120, the storage apparatus 100 according to the second embodiment executes the storage device increasing process of reconfiguring the RAID group 1201 and moving the data of the RAID group 1204 into RAID configured using the increased storage devices. In the following, the storage device increasing process illustrated in FIG. 14 to FIG. 17 will be described along steps in the flowchart.

[Step S21] The configuration management unit 102 acquires the configuration management information stored in the configuration management information storage unit 151.

[Step S22] The configuration control unit 101 reads the data of the RAID group 1204 which has been added by executing the storage-capacity-temporarily-increasing process out of the RAID group 1201 based on the configuration management information acquired at step S21.

[Step S23] The configuration control unit 101 repartitions the data of the RAID group 1204 which has been read out at step S22 in units of stripes (each stripe includes, for example, three data blocks) in accordance with the RAID configuration (for example, RAID 5 (3+1) that includes four storage devices and each stripe to be stored includes three data blocks and one parity data block) configured using the storage devices 1204w to 1204z that have been increased in the storage pool 120.

[Step S24] The configuration control unit 101 generates parity data for the data of the RAID group 1204 repartitioned at step S23.

[Step S25] The configuration control unit 101 reconfigures data of stripes of the RAID group 1204 to be written into the increased storage devices 1204w to 1204z from the data repartitioned at step S23 and the parity data generated at step S24.

[Step S26] The configuration control unit 101 moves the data of the stripes of the RAID group 1204 reconfigured at step S25 into the RAID configured using the storage devices 1204w to 1204z. The configuration control unit 101 writes the data of the stripes of the RAID group 1204 in order starting from the top address of the storage area in the RAID configured using the storage devices 1204w to 1204z and deletes the data of the stripes of the RAID group 1204 which has been read out of the storage devices 1201a to 1201d and the spare storage device 1200e.

[Step S27] The configuration control unit 101 determines whether migration of all data blocks of the RAID group 1204 into the RAID configured using the storage devices 1204w to 1204z has been completed. When migration of all data blocks has been completed (step S27, YES), the process proceeds to step S31 (FIG. 15). On the other hand, when migration of all data blocks is not completed (step S27, NO), the process returns to step S22.

[Step S31] The configuration control unit 101 formats the remaining areas in the RAID configured using the increased storage devices 1204w to 1204z to set a LUN. Then, the process proceeds to step S41 (FIG. 16). With execution of the above mentioned processes, data is read out of and written into areas other than the area used in the RAID group 1204 in the RAID configured using the storage devices 1204w to 1204z.

[Step S41] The configuration control unit 101 reads the data of the RAID group 1201 that has been determined to reduce the storage capacity of the storage pool 120 in the storage-capacity-temporarily-increasing process based on the configuration management information acquired at step S21.

[Step S42] The configuration control unit 101 repartitions the data of the RAID group 1201 read at step S41 in units of stripes in accordance with the RAID configuration of the storage devices (the storage devices 1201a to 1201d) which will be restored by excluding the spare storage device 1200e.

[Step S43] The configuration control unit 101 generates parity data for the data of the RAID group 1201 repartitioned at step S42.

[Step S44] The configuration control unit 101 reconfigures the data of the stripes in the RAID group 1201 to be written into the storage devices the RAID configuration of which is restored from the data repartitioned at step S42 and the parity data generated at step S43.

[Step S45] The configuration control unit 101 executes a data rewriting process of writing again the data of the stripes in the RAID group 1201 reconfigured at step S44 into the storage devices the RAID configuration of which is restored. The configuration control unit 101 writes the data of the stripes in the RAID group 1201 in order starting from the end address of the storage devices the RAID configuration of which is restored.

[Step S46] The configuration control unit 101 determines whether rewriting of all data blocks in the RAID group 1201 has been completed. When rewriting of all data blocks has been completed (step S46, YES), the process proceeds to step S51 (FIG. 17). On the other hand, when rewriting of all data blocks is not completed (step S46, NO), the process returns to step S41.

[Step S51] The configuration control unit 101 excludes the spare storage device 1200e which is set in the RAID group 1201 and restores the RAID configuration of the storage devices (storage devices 1201a to 1201d) which are set in the RAID group 1201 to RAID 5 (3+1).

[Step S52] The configuration control unit 101 sets the spare storage device 1200e excluded at step S51 to a spare.

[Step S53] The configuration control unit 102 updates the configuration management information which is stored in the configuration management information storage unit 151. Then, the process is terminated. As a result, the LUN, the RAID configuration, the storage devices that configure the RAID, and the physical storage capacity of each of the RAID groups 1201 and 1204 that have been changed as a result of execution of the storage device increasing process will be reflected on the configuration management information.

In the storage device increasing process according to the second embodiment, after completion of execution of the processes at step S22 to step S27, the process at step S31, and the processes at steps S41 to S52, the configuration management information is updated based on results of execution of the above processes at step S53. However, the order in which the respective processes are executed is not limited to the above, and the configuration management information may be updated every time execution of each of the processes at step S22 to step S27, the process at step S31, and the processes at steps S41 to S52 is completed.

In general, when a fault has not occurred in a storage device on which a RAID group is set, the storage capacity per storage device of RAID 5 (4+1) is larger than that of RAID 5 (3+1) because the number of data blocks configuring each stripe of RAID 5 (4+1) is larger than that of RAID 5 (3+1) by one (one storage device). However, RAID 5 (3+1) is higher in reliability than RAID 5 (4+1) because the number of storage devices which are set in the RAID group for the parity data of RAID 5 (3+1) is smaller than that of RAID 5 (4+1).

It may sometimes occur that the processing speed of the storage apparatus 100 is reduced while a rebuilding process of restoring data using parity data is being executed when a fault has occurred in one of storage devices on which a RAID group is set. In general, RAID 5 (3+1) is less than RAID 5 (4+1) in load exerted in execution of the rebuilding process and hence in some cases the time taken for execution of the rebuilding process may be relatively short and a time for which the processing speed of the storage apparatus 100 is reduced may be short when RAID 5 (3+1) is adopted. In addition, when spare storage devices are excluded without setting them in a RAID group, a larger number of spare storage devices may be ensured to be used as spares, as compared with the case that a spare storage device is added to be set in a RAID group together with storage devices so as to be used for data reading and writing. Accordingly, the former case is higher in redundancy of the storage pool 120 than the latter case and hence the reliability of the storage apparatus 100 may be more increased in the former case.

Accordingly, in the second embodiment, it may be desirable to restore the RAID configuration to which the RAID group 1201 is set immediately after a storage device has been replaced with a new one or storage devices have been increased in the storage pool 120 from the viewpoints of rebuilding performance and safety.

As described above, in the storage apparatus 100 according to the second embodiment, when the free space in the storage capacity of the storage pool 120 has been reduced, the spare storage device 1200e is used to temporarily increase the storage capacity of the storage pool 120 for a time period until storage devices are increased in the storage apparatus 100. Then, when the storage devices have been increased in the storage pool 120, the spare storage device 1200e is excluded from the RAID group 1201 and is returned to its original status to be used as a spare, and the data of the RAID group 1204 stored so far in the storage area which has been increased using the spare storage device 1200e is moved into the RAID configured using the increased storage devices. With the mentioned operations, it is allowed to reduce the number of times when increasing storage devices in the storage apparatus 100 and the number of times when replacing a storage device with another storage device.

In addition, according to the second embodiment, the spare storage device 1200e is add to the storage pool 120 and used. With the addition of the spare storage device 1200e to the storage pool 120, it may become possible to temporarily increase the storage capacity of the storage pool 120 for a time period until storage devices are increased in the storage pool 120 or a storage device is replaced with another storage device of a larger capacity even when the free space in the storage capacity of the storage pool 120 is reduced and prompt increase or replacement of storage devices is difficult.

Further, after storage devices have been increased in the storage pool 120 or a storage device has been replaced with another storage device and the RAID group 1204 has been set in the increased storage devices, the spare storage device 1200e is excluded from the RAID group 1201 and is on standby to be used as a spare. With the above mentioned operations, the redundancy of the storage devices in the storage pool 120 is ensured and hence the reliability of the storage apparatus 100 may be increased as compared with a state in which the spare storage device 1200e is used.

The above mentioned processing functions may be implemented using a computer. In such case, a program describing contents of processing of functions that the storage apparatus 100 may have is provided. The processing functions are implemented in the computer by executing the program using the computer. The program in which the contents of processing are described may be stored in a computer readable storage medium. As the examples of computer readable storage medium, a magnetic storage device, an optical disk, a magneto-optical disk, a semiconductor memory and the like may be given. As the examples of magnetic storage device, a hard disk device, a flexible disk (FD), a magnetic tape (MT) and the like may be given. As the examples of optical disk, a DVD (Digital Versatile Disc), a DVD-RAM, a CD-ROM (Compact Disc-Read Only Memory), a CD-R (Recordable), a CD-RW (ReWritable) and the like may be given. As the examples of magneto-optical disk, an MO (Magneto-Optical disk) and the like may be given.

When the program is to be made commercially available, portable recording media in which the program is recorded such as DVDs, CD-ROMs and the like are marketed. In addition, the program may be stored in a storage unit of a server computer and the program may be transferred from the server computer to another computer over a network.

The computer that will execute the program stores the program which is recorded in a portable recording medium or which has been transferred from the server computer into the storage unit thereof. Then, the computer reads the program out of the storage unit and executes processes that follow the program. The computer may read the program directly from a portable recording medium and execute the processes that follow the program. Further, the computer may sequentially execute the processes that follow each received program every time each program is transferred from a server computer which is connected with it over a network.

In addition, at least part of the above mentioned processing functions may be implemented using an electronic circuit such as, for example, a DSP (Digital Signal Processor), an ASIC (Application Specific Integrated Circuit), a PLD (Programmable Logic Device) or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage apparatus comprising:
a plurality of first storage media of which a first RAID is composed, a logical storage area of the first RAID for storing data being set over;
a plurality of expansion storage media of which a second RAID is composed;
a spare storage medium that is different from in any of the first storage media or the expansion storage media; and
a configuration control unit that when the spare storage medium is set in the first RAID, sets the logical storage area in the first storage media, and when the expansion storage media are added to the storage apparatus, sets the expansion storage media in the second RAID, excludes the spare storage medium that is set in the first RAID, and moves the logical storage area that is set in the first RAID to the second RAID.

2. The storage apparatus according to claim 1, wherein the configuration control unit reads data of the set logical storage area out of the first RAID, reconfigures stripes, each of the stripes including the data of the set logical storage area and a parity of the data, and writes the reconfigured stripes to move the added logical storage area into the second RAID.

3. The storage apparatus according to claim 1, wherein when the data of the set logical storage area are moved into the second RAID, the configuration control unit writes the data into the logical storage area in the second RAID in order starting from the top address of the added logical storage area.

4. The storage apparatus according to claim 1, wherein when the spare storage medium is excluded from the first RAID, the configuration control unit reads data of the logical storage area that has been included in the first RAID before the set logical storage area is added from the first RAID which the spare storage medium is not yet excluded, reconfigures stripes, each of the stripes including the data of the logical storage area which has been set in the first RAID and the parity of the data which the spare storage medium has been excluded, and writes the reconfigured stripes into the first RAID which the spare storage medium has been excluded.

5. The storage apparatus according to claim 4, wherein when the spare storage medium is excluded from the first RAID, the configuration control unit writes the data of the logical storage area that has been included in the first RAID before the added logical storage area is added into the first RAID which the spare storage medium has been excluded in order starting from the end address thereof.

6. The storage apparatus according to claim 1, wherein when an amount of free spaces has been reduced to a certain amount or less, the configuration control unit adds the spare storage medium to the first RAID.

7. A storage apparatus comprising:
a plurality of first storage media of which a first RAID is composed, a logical storage area of the first RAID for storing data being set over;
a plurality of expansion storage media of which a second RAID is composed;
a spare storage medium that is different from in any of the first storage media or the expansion storage media; and
a configuration management information storage unit that stores configuration management information indicating the storage capacity of each logical storage area;
a configuration management unit that acquires the configuration management information stored in the configuration management information storage unit in response to a request, specifies the logical storage area that uses most the storage capacity based on the acquired configuration management information, and sends a notification that the logical storage area has been specified; and
a configuration control unit that when the request is sent to the configuration management unit and the notification which the logical storage area that uses most the storage capacity has been specified is received from the configuration management unit, sets the spare storage medium in the first RAID which the notified logical storage area is set and sets the logical storage area thereto, wherein when the expansion storage media have been installed, the configuration control unit excludes the spare storage medium set to the first RAID which the notified logical storage area is set from the first RAID, and moves the added logical storage area into the second RAID which is set in the expansion storage media.

8. A computer-readable, non-transitory medium storing a storage apparatus control program that a computer executes a procedure, the procedure comprising:
adding a spare storage medium to a first RAID including a logical storage area for storing data, the logical storage area being set over a plurality of storage media;
excluding the spare storage medium set in the first RAID when a plurality of expansion storage media are installed; and
moving the added logical storage area into a second RAID.

9. A storage apparatus control method for controlling a storage apparatus including a plurality of storage media and a spare storage medium, the storage apparatus control method comprising:
adding the spare storage medium that is used temporarily to a first RAID including a logical storage area for storing data, the logical storage area being set over the plurality of storage media;
excluding the spare storage medium added to the first RAID when a plurality of expansion storage media are added; and
moving the added logical storage area into the second RAID.
